(19) United States
(12) Patent Application Publication
(10) Pub. No.: US 2020/0333695 A1
(43) Pub. Date: Oct. 22, 2020

(54) OPTICAL UNIT AND PROJECTION-TYPE DISPLAY APPARATUS

(71) Applicant: SONY CORPORATION, TOKYO (JP)

(72) Inventor: YASUFUMI FUKUI, KANAGAWA (JP)

(21) Appl. No.: 16/770,806

(22) PCT Filed: Dec. 7, 2018
(86) PCT No.: PCT/JP2018/045124

§ 371 Date: Jun. 8, 2020

(30) Foreign Application Priority Data
Dec. 20, 2017 (JP) 2017-243579

(51) Int. Cl. G03B 21/16; G03B 21/20

(52) U.S. Cl. CPC G03B 21/16; G03B 33/12; G03B 21/204

(57) ABSTRACT

An optical unit according to an embodiment of the present disclosure includes a light source, and a light absorbing device that is provided on an optical path of light emitted from the light source, and includes a radiator.

### TECHNICAL FIELD

The present disclosure relates to, for example, an optical unit including a light source and a projection-type display apparatus having the optical unit.

### BACKGROUND ART

A projection-type display apparatus (a projector) that projects a display of a personal computer or a video image or the like onto a screen is demanded to achieve high luminance to allow for a clear image even at a bright location. In recent years, a light source device used for the projection-type display apparatus employs a solid-state light emitting device such as a light-emitting diode (LED) or a laser diode (LD) as a light source having high luminance.

For example, Patent Literature 1 discloses a projector having two light source devices that respectively emit blue light and light including red light and green light. The two light source devices each have LED that emits the blue light. The light source device emitting the blue light uses the blue light of the LED as it is. The light source device emitting the light including the red and green light applies the blue light emitted from the LED onto a phosphor layer as exciting light and emits light converted by the phosphor layer.

### CITATION LIST

### Patent Literature

Patent Literature 1: Japanese Unexamined Patent Application Publication No. 2011-43596

### SUMMARY

In a projector that uses a solid-state light-emitting device, it has been demanded to improve reliability of an optical device and an optical unit having the optical device.

It is desirable to provide an optical unit and a projection-type display apparatus that are able to improve reliability.

An optical unit according to an embodiment of the present disclosure includes: a light source; and a light absorbing device that is provided on an optical path of light emitted from the light source, and includes a radiator.

A projection-type display apparatus according to an embodiment of the present disclosure includes: an optical unit that generates image light by modulating, on a basis of an input image signal, light from a light source; and a projection optical system that projects the image light generated by the optical unit. The projection-type display apparatus according to an embodiment of the present disclosure includes, as the optical unit, the optical unit according to the embodiment of the present disclosure.

In the optical unit according to the embodiment and the projection-type display apparatus according to the embodiment of the present disclosure, the light absorbing device including the radiator is provided on the optical path of the light emitted from the light source. This enables to convert unnecessary light out of the light emitted from the light source into heat and to discharge the unnecessary light as the heat.

Since the optical unit according to the embodiment and the projection-type display apparatus according to the embodiment of the present disclosure include the light absorbing device including the radiator on the optical path of the light emitted from the light source, the unnecessary light is converted into heat and is thus discharged. This makes it possible to improve reliability by preventing another portion included in the optical unit from being irradiated with the unnecessary light.

It is to be noted that the above-described effects are not necessarily limited and may include any of effects described herein.

### BRIEF DESCRIPTION OF DRAWING

FIG. 1 is a schematic cross-sectional view of one example of a configuration of a light absorbing device according to an embodiment of the present disclosure.

FIG. 2 is a perspective view of the configuration of the light absorbing device illustrated in FIG. 1.

FIG. 3A is a schematic view of another example of a shape of a light absorbing face of the light absorbing device illustrated in FIG. 1.

FIG. 3B is a schematic view of another example of a shape of a light absorbing face of the light absorbing device illustrated in FIG. 1.

FIG. 3C is a schematic view of another example of a shape of a light absorbing face of the light absorbing device illustrated in FIG. 1.

FIG. 3D is a schematic view of another example of a shape of a light absorbing face of the light absorbing device illustrated in FIG. 1.

FIG. 4 is a block diagram that illustrates one example of an overall configuration of a projection-type display apparatus according to an embodiment of the present disclosure.

FIG. 5 is a schematic view of one example of a configuration of the light source device illustrated in FIG. 4.

FIG. 6 is a schematic plan view of a phosphor wheel.

FIG. 7 is a perspective view of one example of a configuration of a light absorbing device according to a modification example of the present disclosure.

FIG. 8 is a perspective view of another example of a configuration of a light absorbing device according to the modification example of the present disclosure.

FIG. 9 is a perspective view of another example of a configuration of a light absorbing device according to the modification example of the present disclosure.

FIG. 10 is a perspective view of another example of a configuration of a light absorbing device according to the modification example of the present disclosure.

FIG. 11 is a perspective view of another example of a configuration of a light absorbing device according to the modification example of the present disclosure.

FIG. 12 is a perspective view of another example of a configuration of a light absorbing device according to the modification example of the present disclosure.

FIG. 13 is a perspective view of another example of a configuration of a light absorbing device according to the modification example of the present disclosure.

FIG. 14A is a schematic top plan view of another example of a configuration of a light absorbing device according to the modification example of the present disclosure.

FIG. 14B is a perspective view of the configuration of the light absorbing device illustrated in FIG. 14A.

### MODES FOR CARRYING OUT THE INVENTION

In the following, an embodiment of the present disclosure is described in detail with reference to the drawings. The following descriptions are only examples of the present disclosure, and the present disclosure should be not limited to the following descriptions. Further, the present disclosure is not limited to the following descriptions in terms of arrangement, dimensions, a dimension ratio, and the like of each configuration element in each drawing. In addition, it should be noted that the description is made in the following order.

1. Embodiment (An example of a light absorbing device having a radiator)

1-1. A configuration of a light absorbing device

1-2. A configuration of a projection-type display apparatus

1-3. Workings and Effect

### 2. Modification

### 1. Embodiment

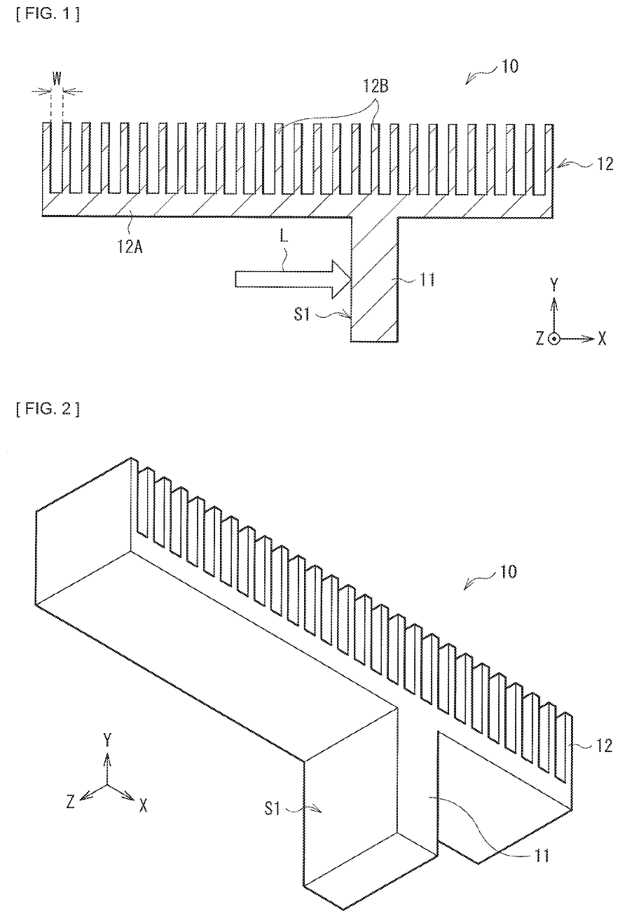

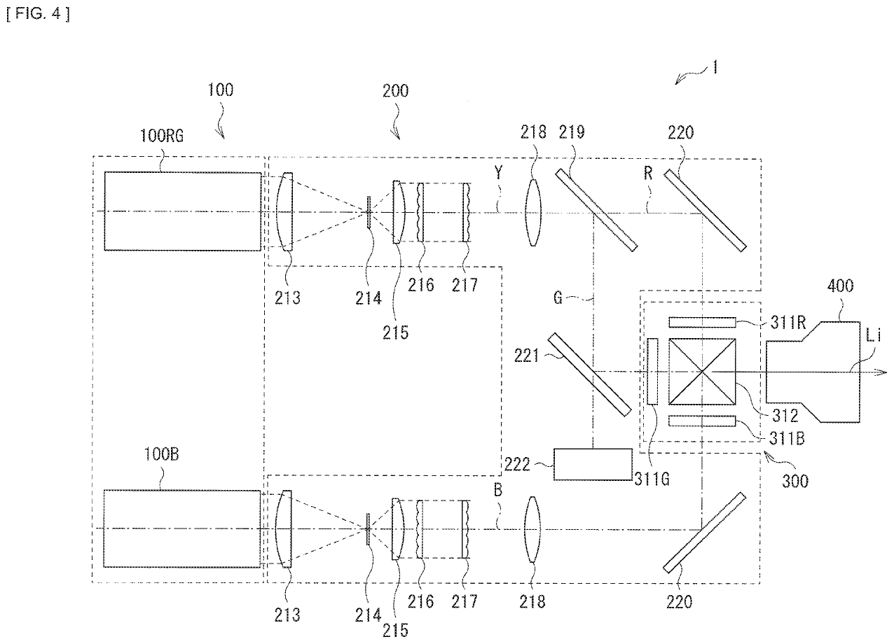

FIG. 1 schematically illustrates a cross-sectional configuration of a light absorbing device 10 according to an embodiment of the present disclosure. FIG. 2 is a perspective view of the light absorbing device 10 illustrated in FIG. 1. For example, the light absorbing device 10 is used for a projection-type display apparatus described below (a projection-type display apparatus 1; see FIG. 4). The projection-type display apparatus 1 includes, for example, a light source device 100, an optical unit having a light source optical system 200 and an image generator 300, and a projection optical system 400. The optical unit includes, as the light source device 100, two light source devices including a light source device 100RG that emits yellow light Y (fluorescent light FL) and a light source device 100B that emits blue light B. The optical unit according to the present embodiment includes, for example, a configuration in which the light absorbing device 10 having a light absorber 11 and a radiator 12 is provided on an optical path of the yellow light Y (the fluorescent light FL) emitted from the light source device 100RG.

(1-1. Configuration of Light Absorbing Device)

As described above, the light absorbing device 10 includes the light absorber 11 and the radiator 12. The light absorber 11 absorbs light and converts the light into heat. The radiator 12 radiates heat converted by the light absorber 11 to discharge the heat.

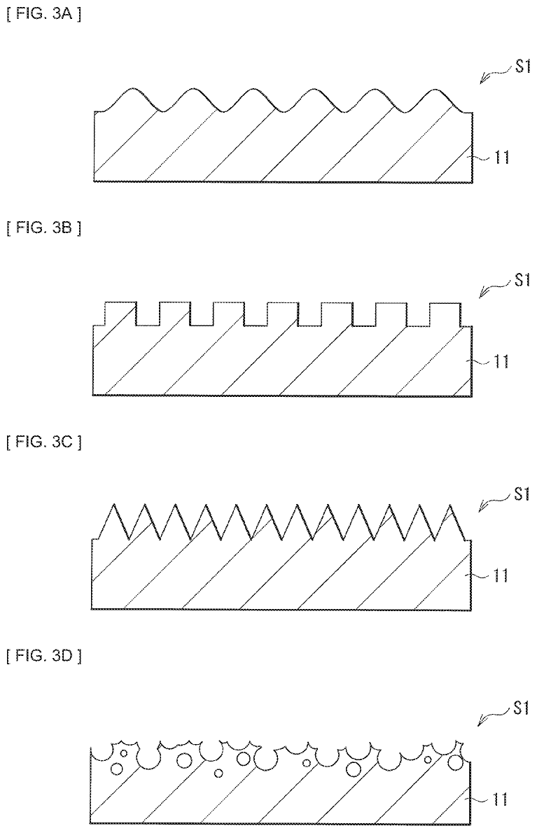

The light absorber 11 is, for example, a block-shaped member having a light absorbing face S1 (an irradiation face). In the projection-type display apparatus 1, for example, the light absorbing face S1 is provided on the optical path of the yellow light Y, for example, in such a manner as to substantially face the yellow light Y. For example, the light absorbing face S1 in FIG. 1 is provided to allow an angle between light L traveling straight in an X axis direction and the light absorbing face S1 (a YZ plane) to be a substantially right angle. The light absorbing face S1 may have a shape of a flat plate, but preferably provides an irregular reflection face, for example, as illustrated in FIGS. 3A to 3D.

For example, the light absorbing face S1 may provide a wave-shaped face in which a cross-section has a wave shape, for example, as illustrated in FIG. 3A. In addition, the light absorbing face S1 may provide a plurality of projections and depressions in which a cross-section thereof has an irregular shape, for example, as illustrated in FIG. 3B. Further, the light absorbing face S1 may provide, for example, a plurality of conical projections in which a cross-section thereof has a saw blade shape, for example, as illustrated in FIG. 3C. Alternatively, the light absorbing face S1 may have a porous shape such as a sponge, for example, as illustrated in FIG. 3D. In this way, since the light absorbing face S1 provides the irregular reflection face, it is possible to irregularly reflect the light that has failed to be absorbed by the light absorbing face S1 and thereby to prevent a specific portion from concentration of the light reflected by the light absorbing face S1.

The light absorber 11 has roles of light absorption and heat transmission. For these reasons, the light absorber 11 preferably uses a material having high light absorption and heat conductivity. In addition, the light absorber 11 preferably uses a material having high heat-resisting temperature. Such a material is a metal material. Further, considering a light relative density, high prevention for rust/corrosion, easy manufacturing, and cost reduction from a production viewpoint, for example, aluminum with black decoration or the like is used preferably. Alternatively, a resin material may be used for formation. In addition, the light absorber 11 and the light absorbing face S1 portion may be formed using different materials. A size of the light absorber 11 may be at least equal to or greater than light projection area at a position where the light absorbing device 10 is provided.

The radiator 12 has a supporter 12A that is continuous to the light absorber 11, and a plurality of fins 12B provided on the supporter 12A. For example, the supporter 12A extends along the traveling direction of the light L entering the light absorbing face S1 (the X axis direction), and the plurality of fins 12B stands on the supporter 12A, for example, at a constant interval W. Note that the interval W of the plurality of fins 12B may not necessarily be constant and may be appropriately adjusted in accordance with a circumferential shape where the light absorbing device 10 is provided.

The radiator 12 preferably uses a material having high heat conductivity and high heat-resisting temperature. In addition, a material with high radiation factor allows for improvement of heat dissipation performance. Such a material is a metal material. Further, considering a light relative density, high prevention for rust/corrosion, easy manufacturing, and cost reduction from a production viewpoint, for example, aluminum or the like be used preferably.

(1-2. Configuration of Projection-Type Display Apparatus)

FIG. 4 is a schematic diagram that illustrates an overall configuration of the projection-type display apparatus (the projection-type display apparatus 1) according to the embodiment of the present disclosure. The projection-type display apparatus 1 projects an image (an image light) onto an unillustrated screen such as a wall surface, and includes, as described above, the light source device 100, the optical unit having the light source optical system 200 and the image generator 300, and the projection optical system 400. The projection-type display apparatus 1 according to the present embodiment includes, as the light source device 100, the light source device 100RG that emits the yellow light Y and the light source device 100B that emits the blue light B. For example, the light absorbing device 10 illustrated in FIG. 1 is provided on the optical path of the yellow light Y emitted from the light source device 100RG.

In addition, the projection-type display apparatus 1 illustrated in FIG. 4 exemplarily illustrates a projection-type display apparatus having a transmission-type three-LCD (liquid crystal display) system that performs light modulation, for example, by transmission-type liquid crystal panels including liquid crystal panels 311R, 311G, and 311B, which however should not be limited to this type. For example, the projection-type display apparatus may be a projection-type display apparatus of a reflection-type three-LCD system that performs the light modulation by reflection-type liquid crystal panels. The projection-type display apparatus 1 according to the present embodiment may also be applied to a projector that uses, for example, a Digital Micro-mirror Device (DMD) and the like instead of the transmission-type liquid crystal panels and the reflection type liquid crystal panels.

The light source device 100 includes light sources that emit red light R, green light G, and blue light B, which are necessary for a color image display. In the present embodiment, the light source device 100 includes the two light source devices that are the light source device 100RG emitting the yellow light Y including the red light R and the green light G, and the light source device 100GB emitting the green light G and the blue light B. Further, the light source device 100 includes, as a light source, a solid-state light source such as, for example, a semiconductor laser (LD) that oscillates blue laser light or a light-emitting diode (LED).

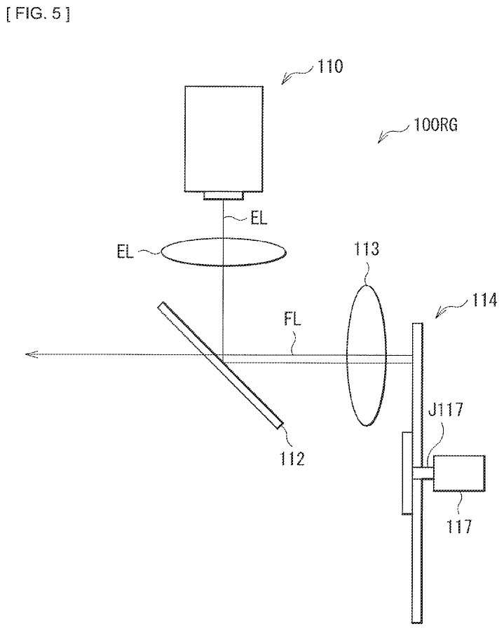

FIG. 5 is a schematic diagram that illustrates an overall configuration of the light source device 100RG. The light source device 100RG includes a light source 110, condensing optical systems 111 and 113, a dichroic mirror 112, and a phosphor wheel 114. Each member included in the light source device 100RG except for the light source 110 is provided, on the optical path of the yellow light Y (the fluorescent light FL) emitted from the phosphor wheel 114, in order of the condensing optical system 113 and the dichroic mirror 112 from the phosphor wheel 114. The light source 110 is provided in a direction orthogonal to the optical path of the fluorescent light FL and at a position opposing the dichroic mirror 112 while interposing the condensing optical system 111.

The light source 110 includes a solid-state light emitting device that emits light having a predetermined wavelength. In the present embodiment, as the solid-state light emitting device, the semiconductor laser device is used which oscillates excited light EL (for example, blue laser light having 445 nm or 455 nm wavelength). The light source 110 emits the excited light EL.

Note that, in a case where the light source 110 includes the semiconductor laser device, the excited light EL having a predetermined output may be obtained by one semiconductor laser device; however, the excited light EL having the predetermined output may be obtained by combining the pieces of light emitted from a plurality of semiconductor laser devices. Further, the wavelength of the excited light EL is not limited to the value described above, and any wavelength may be used as long as the wavelength falls within a wavelength range of light that is referred to as the blue light.

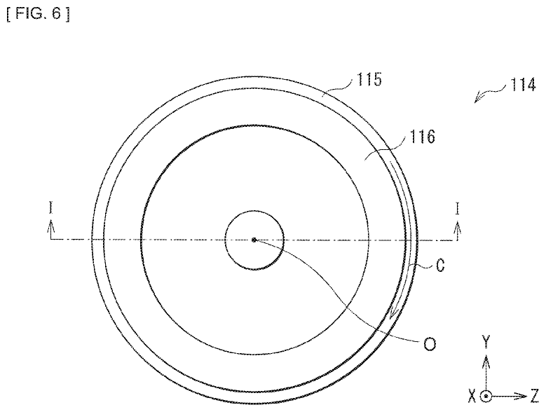

FIG. 6 illustrates a plane configuration of the phosphor wheel 114. The phosphor wheel 114 includes a support substrate 115, for example, that has a shape of a disc. A phosphor layer 116 is provided on the support substrate 115. A motor 117 is coupled to the support substrate 115 via a shaft J117. The motor 117 makes it possible for the support substrate 115 to rotate along an arrow C around the shaft J117 passing through a center O of the support substrate 115.

The phosphor layer 116 includes, for example, phosphor particles as a fluorescent material and has a ring shape, for example. The phosphor particle is a particle phosphor absorbing the excited light EL applied from the outside (here, the light source 110) and outputting the fluorescent light FL. As the phosphor particle, a fluorescent material is used, for example, which is excited by blue laser light having a blue light wavelength range (for example, 400 nm to 470 nm) and outputs yellow fluorescent light (light having a wavelength range between the red wavelength range and the green wavelength range). Such a fluorescent material is, for example, an YAG (yttrium/aluminum/garnet)-based material.

The condensing optical system 111 condenses the excited light EL emitted from the light source 110 to a predetermined spot diameter and outputs the excited light EL toward the dichroic mirror 112.

The dichroic mirror 112 selectively reflects light having a predetermined wavelength range and selectively passes light having other wavelength range. Specifically, the dichroic mirror 112 reflects the blue laser light (the blue light B; the excited light EL) outputted from the light source 110 toward the condensing optical system 113, and allows the yellow light Y (the fluorescent light FL), which has entered from the phosphor wheel 114 and has passes through the condensing optical system 113, to enter the light source optical system 200 (described later).

The condensing optical system 113 condenses the excited light EL reflected by the dichroic mirror 112 to a predetermined spot diameter and outputs the condensed excited light EL toward the phosphor wheel 114. In addition, the condensing optical system 113 outputs the fluorescent light FL outputted from the phosphor wheel 114 toward the dichroic mirror 112.

Note that the configuration of the light source device 100RG illustrated in FIG. 5 is one example and should not be limited thereto. For example, a configuration of a light source device using a polarization system may be employed in which a ¼ wavelength plate or the like is provided, for example, between the light source 110 and the phosphor wheel 114.

In the light source optical system 200, a plurality of optical devices is provided on each of the optical paths of the pieces of light (the yellow light Y and the blue light B) emitted from the light source device 100RG and the light source device 100B. For example, a condensing lens 213, a diffusion plate 214, a collimator lens 215, fly-eye lenses 216 and 217, a condenser lens 218, and a dichroic mirror 219 are provided on the optical path of the light source device 100RG. For example, a condensing lens 213, a diffusion plate 214, a collimator lens 215, fly-eye lenses 216 and 217, a condenser lens 218, and a reflection mirror 220 are provided on the optical path of the light source device 100B.

The pieces of light (the yellow light Y and the blue light B) emitted from the light source devices 100RG and 100B are each condensed on the diffusion plate 214 by the condensing lens 213. The condensed yellow light Y and blue light B are each diffused by the diffusion plate 214 and each enter the collimator lens 215. The yellow light Y and the blue light B having passed through the collimator lenses 215 are each divided into a plurality of light beams by macro lenses of the fly-eye lens 216 and imaged on the corresponding macro lenses of the fly-eye lens 217. Each of the micro lenses of the fly-eye lens 217 functions as a secondary light source. The yellow light Y and the blue light B having passed through the fly-eye lenses 217 are each condensed by the condenser lens 218.

The dichroic mirror 219 is provided on the optical path of the yellow light Y. The yellow light Y condensed by the condenser lens 218 enters a dichroic mirror 221 and is optically split into the red light R and the green light G by the dichroic mirror 221.

Specifically, the red light R included in the yellow light Y selectively passes through the dichroic mirror 219 and the light excluding the red light R (for example, the green light G) is selectively reflected by the dichroic mirror 219. The reflection mirror 220 is provided on the optical path of the red light R that has passed through the dichroic mirror 219. The dichroic mirror 221 is provided on the optical path of the green light G reflected by the dichroic mirror 219. In the present embodiment, a light absorbing device 222 is further provided downstream of the dichroic mirror 221. This light absorbing device 222 corresponds to the light absorbing device 10 described above.

In the projection-type display apparatus 1 according to the present embodiment, as described above, the red light R and the green light G are obtained as follows. That is, the yellow light Y is extracted at the phosphor layer 116 of the phosphor wheel 114 using the blue laser light (the blue light B) emitted from the light source 110 as the excited light, and is optically split into the red light R and the green light G at the dichroic mirror 219, for example. However, this yellow light Y includes the blue light B that has failed to be converted at the phosphor layer 116. The blue light B is reflected by the dichroic mirror 219, for example, together with the green light G toward the dichroic mirror 221. At the dichroic mirror 221, the green light G is selectively reflected. At the dichroic mirror 221, another wavelength light Lx including the blue light B passes therethrough and enters the light absorbing face S1 of the light absorbing device 222, and is converted into heat at the light absorber 11.

The reflection mirror 220 is provided on the optical path of the blue light B. The blue light B condensed by the condenser lens 218 is reflected by the reflection mirror 220.

The image generator 300 includes the liquid crystal panels 311R, 311G, and 311B, and a dichroic prism 312.

The liquid crystal panels 311R, 311G, and 311B are each a transmission-type liquid crystal panel, and generate respective pieces of color image light by modulating entered light on the basis of an input image signal. The liquid crystal panel 311R is provided on the optical path of the red light R reflected by the reflection mirror 220. The liquid crystal panel 311R is driven, for example, by a digital signal modulated by a pulse width modulation (PWM) in accordance with a red image signal, and has a function of thereby modulating the entered light and of causing the modulated light to pass therethrough toward the dichroic prism 312. The liquid crystal panel 311G is provided on the optical path of the green light G reflected by the dichroic mirror 221. The liquid crystal panel 311G is driven, for example, by a digital signal modulated by the pulse width modulation (PWM) in accordance with a green image signal, and has a function of thereby modulating the entered light and of causing the modulated light to pass therethrough toward the dichroic prism 312. The liquid crystal panel 311B is provided on the optical path of the blue light B reflected by the reflection mirror 220. The liquid crystal panel 311B is driven, for example, by a digital signal modulated by the pulse width modulation (PWM) in accordance with a blue image signal, and has a function of thereby modulating the entered light and of causing the modulated light to pass therethrough toward the dichroic prism 312.

The red light R, the green light G, and the blue light B respectively having passed through the liquid crystal panels 311R, 311G, and 311B enter the dichroic prism 312. The dichroic prism 312 combines the red light R, the green light G, and the blue light B entered from the three directions in a superimposing fashion, and outputs the combined image light Li toward the projection optical system 400.

The projection optical system 400 includes a plurality of lenses, and enlarges the image light Li combined by the dichroic prism 312 to project the image light Li onto a screen (not illustrated).

(1-3. Workings and Effect)

As described above, a projection-type display apparatus is demanded to achieve high luminance to allow clear image light to be obtained even at a bright location. The solid-state light emitting device such as the LED or the LD has been employed as the light source having high luminance. Further, a projection-type display apparatus has been developed, as a projection-type display apparatus having high luminance and superior color balance of a projection image, which includes the two light source devices using the solid-state light emitting devices as the light sources and emitting, for example, the blue light and the light (for example, the yellow light) that includes the red light and the green light.

The projection-type display apparatus including the two light source devices as described above, employs a system that: uses the LED that oscillates the blue light as the light source; converts the blue light into the yellow light by the phosphor; and uses the red light and the green light by optically splitting the yellow light into the red light and the green light. However, the yellow light includes the blue light that has failed to be converted by the phosphor, raising an issue in which a degradation occurs in other optical devices and units included in the projection-type display apparatus.

In contrast, according to the present embodiment, the light absorber 11 and the light absorbing device 10 including the radiator 12 are provided on the optical path of the yellow light Y emitted from the light source device 100RG. In detail, the yellow light Y (the fluorescent light FL) emitted from the light source device 100RG is optically split into the red light R and the green light G by the dichroic mirror 219 provided on the optical path thereof. The dichroic mirror 219 selectively passes through the red light R out of the yellow light Y and reflects other wavelength light (for example, the green light G). The dichroic mirror 221 is provided on the optical path of the reflected green light G. This dichroic mirror 221 reflects only the green light G, and causes other wavelength light (the unnecessary light) Lx including the blue light B to pass therethrough except the green light G. The light absorbing device 10 is provided downstream of the dichroic mirror 221, i.e., on the optical path of the unnecessary light Lx that has passed through the dichroic mirror 221, and at the position where the light absorbing face S1 of the light absorber 11 substantially faces thereto. As a result, the unnecessary light Lx is absorbed by the light absorbing face S1. The absorbed unnecessary light Lx is converted into heat by the light absorber 11 and radiated by the radiator 12.

As described above, in the optical unit according to the present embodiment, for example, the light absorber 11 and the light absorbing device 10 including the radiator 12 are provided on the optical path of the green light G that is optically split from the red light R by the dichroic mirror 219, out of the yellow light Y emitted from the light source device 100RG. The dichroic mirror 221 that selectively reflects only the green light G is provided upstream of the light absorbing device 10. The light absorbing device 10 absorbs the unnecessary light Lx including the blue light B that has passed through the dichroic mirror 221. The absorbed unnecessary light Lx is converted into heat by the light absorber 11 and radiated by the radiator 12 to be discharged. This makes it possible to avoid the degradation in other members included in the optical unit, for example, caused by the unconverted blue light B that is included in the yellow light Y converted and outputted by the phosphor, and thereby to improve reliability.

In addition, the present embodiment makes it possible to avoid mixing of the blue light B with the red light R and the green light G, making it possible to achieve improvement in display quality in addition to the above effect.

Further, the present embodiment provides the irregular reflection face as the light absorbing face S1 of the light absorbing device 10. This makes it possible to prevent a specific portion from the concentration of the unnecessary light (for example, the blue light B), owing to the irregular reflection of the light unabsorbed by the light absorbing face S1. This makes it possible to avoid the degradation in other members included in the optical unit, and to more improve the reliability.

Next, modification examples of the above embodiment will be described. It should be noted that, in the following description, configuration elements similar to those of the above embodiment are denoted with the same reference signs, and the description thereof is omitted as necessary.

### 2. Modification Examples

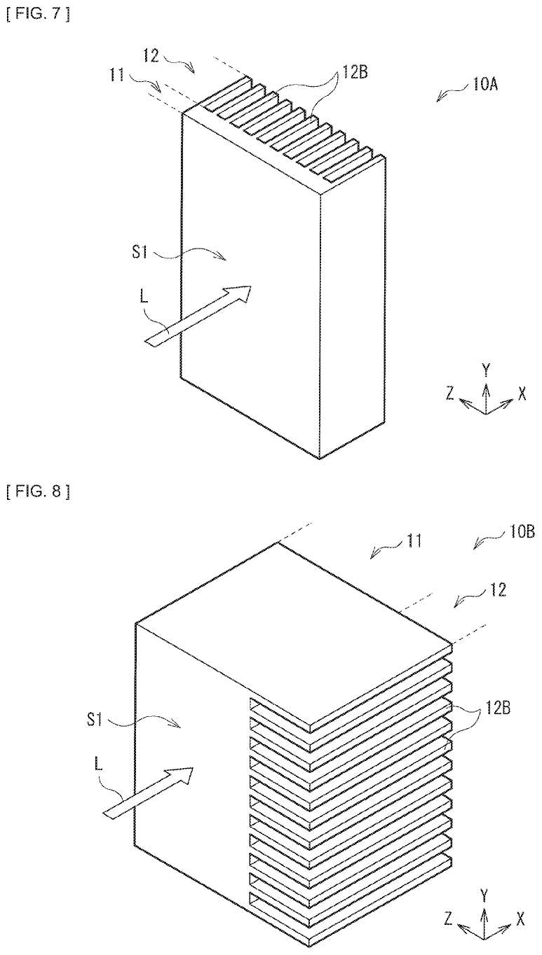

FIG. 7 is a perspective view of an exemplary configuration of a light absorbing device (a light absorbing device 10A) according to a modification example of the present disclosure. As with the above embodiment, the light absorbing device 10A is used for a projection-type display apparatus (the projection-type display apparatus 1; see FIG. 4) that includes, as the light source device 100, the two light source devices including the light source device 100RG emitting the yellow light Y (the fluorescent light FL) and the light source device 100B emitting the blue light B. The light absorbing device 10A of the present modification example differs from the above embodiment in that, for example, the light absorber 11 serves as the supporter 12A of the radiator 12 according to the above embodiment, and that the plurality of fins 12B included in the radiator 12 is provided on a face opposite to the light absorbing face S1 of the light absorber 11.

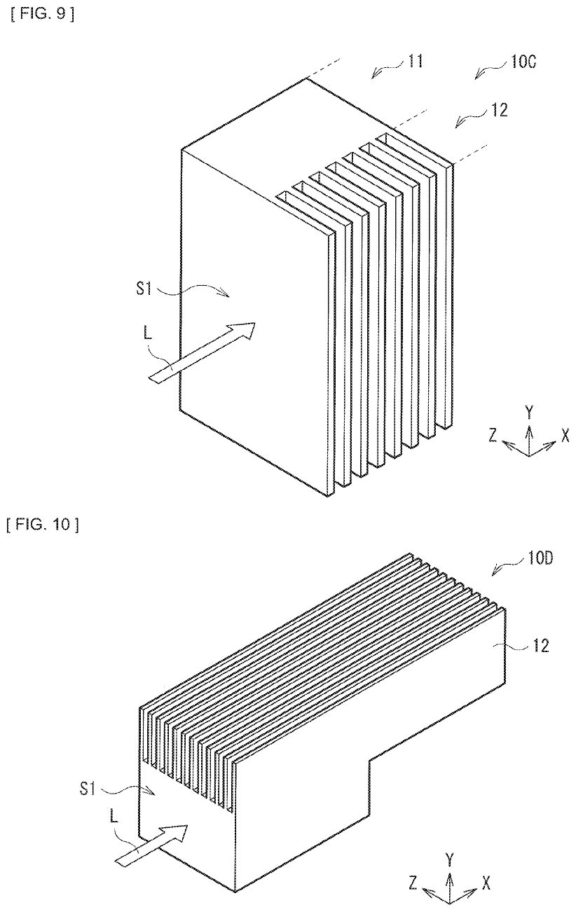

As described above, a shape of the light absorbing device 10 according to the present disclosure is not limited and may be variously modified. For example, as illustrated in FIG. 8, the plurality of fins 12B included in the radiator 12 may be provided, for example, on a side face of the block-shaped light absorber 11 (a light absorbing device 10B). In the light absorbing device 10B, the plurality of fins 12B is provided side-by-side in such a manner as to be, for example, orthogonal to a traveling direction of light L (the X axis direction). Note that the array direction of the plurality of fins 12B is not particularly limited. For example, as with a light absorbing device 10C illustrated in FIG. 9, the plurality of fins 12B may be provided side-by-side in the same direction as the traveling direction of the light L (the X axis direction).

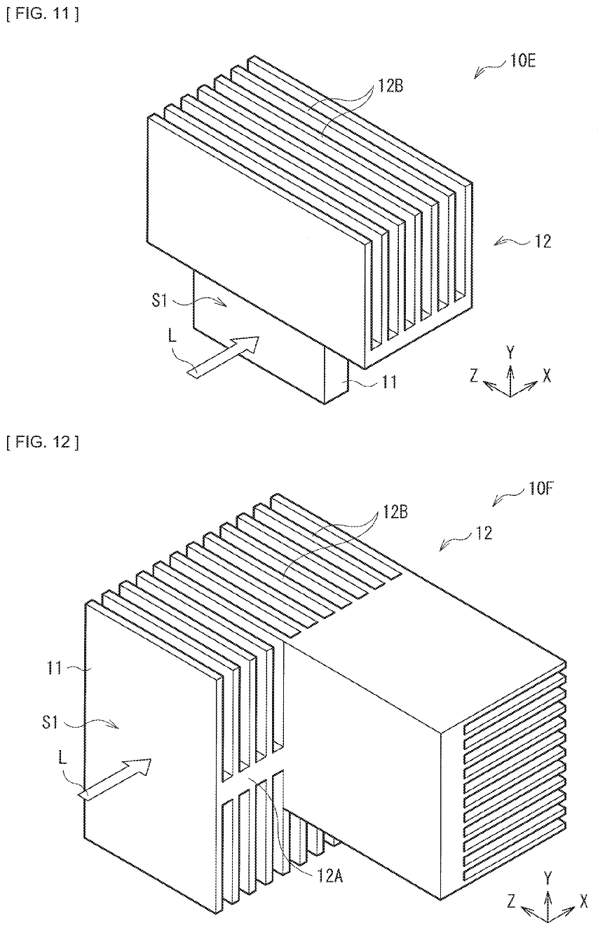

In addition, as illustrated in FIG. 10, the plurality of fins 12B included in the radiator 12 may be provided on an upper face of the block-shaped light absorber 11 (a light absorbing device 10D). In the light absorbing device 10D, the plurality of fins 12B is provided side-by-side in such a manner as to be, for example, orthogonal to the traveling direction of the light L (the X axis direction). Alternatively, as with a light absorbing device 10E illustrated in FIG. 11, the plurality of fins 12B may be provided side-by-side, for example, on an upper face of the block-shaped light absorber 11 in the same direction as the traveling direction of the light L (the X axis direction).

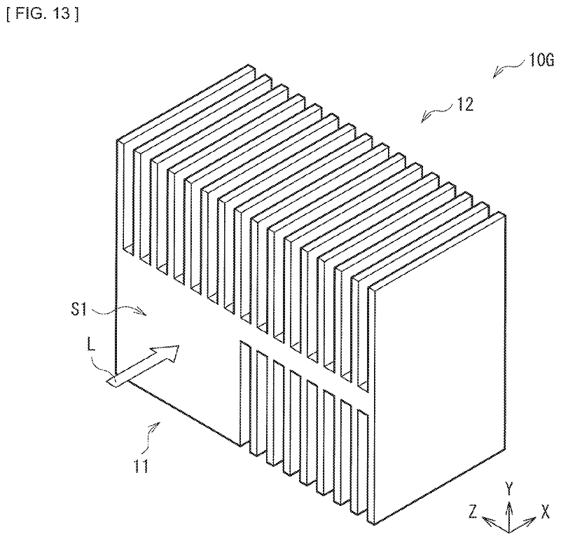

Further, as illustrated in FIG. 12, the supporter 12A may be provided on a back face of the light absorber 11, for example, which extends in the traveling direction of the light L. The plurality of fins 12B may be provided on an upper face and a lower face of the supporter 12A, and another plurality of fins may be provided (a light absorbing device 10F). Furthermore, as illustrated in FIG. 13, the plurality of fins 12B may be provided, for example, on the side face and the upper face in such a manner as to surround the block-shaped light absorber 11 (a light absorbing device 10G).

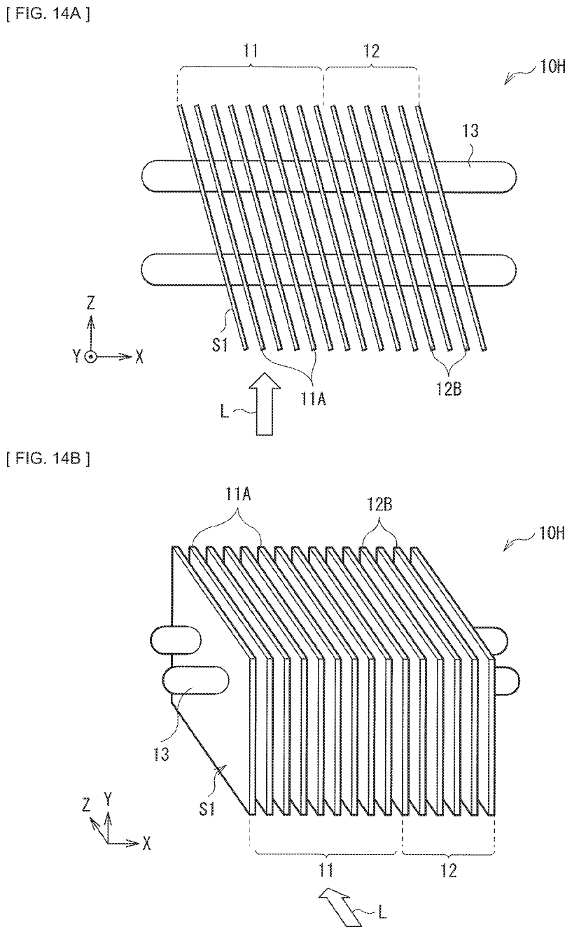

Furthermore, the light absorber 11 is not limited to the single member such as any of the light absorbing devices 10 and 10A to 10G illustrated in FIG. 1 and FIGS. 7 to 13, and may be provided with an assembly including a plurality of members. For example, as with a light absorbing device 10H illustrated in FIGS. 14A and 14B, the light absorber 11 may be provided with a plurality of flat plates. FIG. 14A is a schematic view of the light absorbing device 10H as viewed from above, and FIG. 14B is a perspective view of the light absorbing device 10H illustrated in FIG. 14A. In a case of providing the light absorber 11 with the plurality of flat plates (fins 11A), the plurality of fins 11A is integrated, for example, by heat pipes 13. The unnecessary light Lx is converted into heat by the light absorber 11, and the heat is conveyed out of the optical path via the heat pipes 13. For example, the conveyed heat is radiated by the radiator 12 including the plurality of fins 12B integrated with the light absorber 11 by the heat pipes 13. Note that the plurality of fins 11A included in the light absorber 11 may not necessarily be provided to face the unnecessary light Lx. For example, as illustrated in FIG. 14A, the light absorbing face S1 may be inclined relative to the unnecessary light Lx.

As described above, a shape and the formation position of the radiator 12 are not particularly limited, and may be freely designed in accordance with configurations of other optical devices included in the optical unit. It is possible to improve an efficiency of heat radiation of the light absorbing device 10 by increasing the surface areas of the fins 12B included in the radiator 12.

The present technology is described above with reference to the embodiment and the modification examples, but the present technology is not limited to the embodiment, etc., and allows for various modifications. In the embodiment described above, the configuration elements of each optical system have been described specifically; however, it is not necessary to include all of the configuration elements, and other configuration elements may be further provided.

Moreover, an apparatus other than the foregoing projector may be configured as the projection-type display apparatus according to the present technology.

In addition, the present technology allows for the following configurations.

(1)

An optical unit including:

a light source; and

a light absorbing device that is provided on an optical path of light emitted from the light source, and includes a radiator.

(2)

The optical unit according to (1), further including a dichroic mirror, in which

the dichroic mirror is provided upstream of the light absorbing device on the optical path of the light emitted from the light source.

(3)

The optical unit according to (1) or (2), in which the light source further includes a wavelength conversion device that converts a wavelength of the light emitted from the light source.

(4)

The optical unit according to (3), in which

the wavelength conversion device includes a phosphor layer on a substrate that is rotatable around a rotating axis, and

the phosphor layer is excited by the light emitted from the light source and emits fluorescent light.

(5)

The optical unit according to any one of (1) to (4), in which the light source includes a first light source and a second light source each having one or more optical devices.

(6)

The optical unit according to any one of (1) to (5), in which

the light absorbing device includes an irradiation face that is to be irradiated with the light emitted from the light source, and

the irradiation face has a shape of a flat plate.

(7)

The optical unit according to any one of (1) to (5), in which

the light absorbing device includes an irradiation face that is to be irradiated with the light emitted from the light source, and

the irradiation face is a wave-shaped face.

(8)

The optical unit according to any one of (1) to (5), in which

the light absorbing device includes an irradiation face that is to be irradiated with the light emitted from the light source, and

the irradiation face has an irregular shape.

(9)

The optical unit according to any one of (1) to (5), in which

the light absorbing device includes an irradiation face that is to be irradiated with the light emitted from the light source, and

the irradiation face has a plurality of conical projections.

(10)

The optical unit according to any one of (1) to (5), in which

the light absorbing device includes an irradiation face that is to be irradiated with the light emitted from the light source, and

the irradiation face has a porous shape.

(11)

The optical unit according to any one of (1) to (10), in which the radiator includes a plurality of fins.

(12)

A projection-type display apparatus including:

an optical unit that generates image light by modulating, on a basis of an input image signal, light from a light source; and

a projection optical system that projects the image light generated by the optical unit,

the optical unit including
a light source, and
a light absorbing device that is provided on an optical path of light emitted from the light source, and includes a radiator.

The present application claims priority based on Japanese Patent Application No. 2017-243579 filed with the Japan Patent Office on Dec. 20, 2017, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An optical unit comprising:
a light source; and
a light absorbing device that is provided on an optical path of light emitted from the light source, and includes a radiator.

2. The optical unit according to claim 1, further comprising a dichroic mirror, wherein
the dichroic mirror is provided upstream of the light absorbing device on the optical path of the light emitted from the light source.

3. The optical unit according to claim 1, wherein the light source further includes a wavelength conversion device that converts a wavelength of the light emitted from the light source.

4. The optical unit according to claim 3, wherein
the wavelength conversion device includes a phosphor layer on a substrate that is rotatable around a rotating axis, and
the phosphor layer is excited by the light emitted from the light source and emits fluorescent light.

5. The optical unit according to claim 1, wherein the light source includes a first light source and a second light source each having one or more optical devices.

6. The optical unit according to claim 1, wherein
the light absorbing device includes an irradiation face that is to be irradiated with the light emitted from the light source, and
the irradiation face has a shape of a flat plate.

7. The optical unit according to claim 1, wherein
the light absorbing device includes an irradiation face that is to be irradiated with the light emitted from the light source, and
the irradiation face is a wave-shaped face.

8. The optical unit according to claim 1, wherein
the light absorbing device includes an irradiation face that is to be irradiated with the light emitted from the light source, and
the irradiation face has an irregular shape.

9. The optical unit according to claim 1, wherein
the light absorbing device includes an irradiation face that is to be irradiated with the light emitted from the light source, and
the irradiation face has a plurality of conical projections.

10. The optical unit according to claim 1, wherein
the light absorbing device includes an irradiation face that is to be irradiated with the light emitted from the light source, and
the irradiation face has a porous shape.

11. The optical unit according to claim 1, wherein the radiator includes a plurality of fins.

12. A projection-type display apparatus comprising:
an optical unit that generates image light by modulating, on a basis of an input image signal, light from a light source; and
a projection optical system that projects the image light generated by the optical unit,
the optical unit including
a light source, and
a light absorbing device that is provided on an optical path of light emitted from the light source, and includes a radiator.
